(19) United States
(12) Patent Application Publication
(10) Pub. No.: US 2004/0229198 A1
(43) Pub. Date: Nov. 18, 2004

(54) Methods and systems for computer-based neurocognitive testing

(75) Inventors: Alan F. Boyd, Durham, NC (US); Geoffrey M. Hibble, Cottesloe (AU); Dion Bruce Whittaker, Perth (AU)

Correspondence Address: JENKINS & WILSON, PA, 3100 TOWER BLVD, SUITE 1400, DURHAM, NC, 27707, US

(73) Assignee: CNS Vital Signs, LLC

(21) Appl. No.: 10/439,192

(22) Filed: May 15, 2003

(51) Int. Cl. G09B 19/00

(52) U.S. Cl. 434/236

(57) ABSTRACT

Methods and systems for computer-based neurocognitive testing are disclosed. A system for computer-based neurocognitive testing includes stand-alone agent software capable of executing on a general purpose computing platform. The agent software administers a battery of neurocognitive tests to the subject and records the subject's responses. The subject's reaction times for individual responses may be recorded, even in tests for which reaction times for individual responses were not conventionally recorded. The reactions may be recorded with millisecond accuracy, even when the agent software is executing over a non-real-time operating system. The agent software generates an agent report indicating the subject's responses to the tests and reaction times. The agent software may upload the test results to the server. The server may control access to the test results and to agent software and produce more sophisticated clinically useful reports such as longitudinal comparisons of the subject to peers and perhaps other dissimilar subjects.

### TECHNICAL FIELD

The present invention relates to methods and systems for computer-based neurocognitive testing. More particularly, the present invention relates to methods and systems for computer-based neurocognitive testing in which conventional neurocognitive tests are implemented as computer software executable on a general purpose computing platform and in which a keystroke diary of an entire test session is collected, even for tests for which reaction times for individual responses have not conventionally been recorded.

### BACKGROUND ART

Neurocognitive testing includes testing of brain and central nervous system functions by presenting a subject with stimuli and recording the subject's response to the stimuli. Some examples of conventional neurocognitive tests include verbal memory tests, visual memory tests, motor speed tests, fine motor control tests, complex attention tests, visual perception speed tests, information processing speed tests, executive function tests, reaction time tests, speed accuracy tradeoff assessment tests, and cognitive flexibility tests. Conventionally, these tests have been administered to a subject by having the subject visit a physician's office and having the subject take the test in hard-copy format. Some neurocognitive tests, such as the finger tapping test, have been automated using computers. However, administering the finger tapping test using a computer has conventionally required special purpose hardware to accurately measure a subject's reaction time and may have not produced millisecond precision or recorded reaction times for individual responses.

Of the neurocognitive tests listed above, the goal of some of the tests, such as motor speed tests, is to measure the subject's response to various stimuli. Accordingly, as indicated above, some of these tests, such as finger tapping tests, have been automated using special purpose computer hardware. Other tests, such as verbal memory and visual memory tests, are still given in hard-copy format since reaction times for individual responses have not conventionally been measured. Giving tests in hard-copy format is labor intensive and fails to produce a total neurocognitive profile of a subject.

Accordingly, in light of the difficulties associated with conventional neurocognitive testing, there exists a long felt need for improved methods and systems for computer-based neurocognitive testing that records both the correct and incorrect responses as well as millisecond precision to measure the time required for subject response.

### DISCLOSURE OF THE INVENTION

The present invention includes methods and systems for computer based neurocognitive testing. In one implementation, the method includes presenting a subject with one or more neurocognitive tests via a general purpose computing platform. At least one of the neurocognitive tests presented is a test for which reaction times for individual responses were not conventionally measured. Examples of tests for which reaction times for individual responses were not conventionally measured include tests for which the primary purpose was to measure a subject's memory or ability to reason. Examples of such tests include verbal memory tests, visual memory tests, and shifting attention tests. Even in some tests for which overall timing or average response time was measured, reaction times for individual responses may not have been conventionally measured. Examples of such tests include finger tapping tests, complex attention tests, Stroop tests, symbol digit coding tests, and reaction time-simple choice tests.

For each of the neurocognitive tests, software associated with the general purpose computing platform records the subject's responses. In addition, the software may record the subject's reaction times for individual responses, even for the test or tests for which reaction times for individual responses were not conventionally measured. Recording the reaction times for individual responses in a battery of neurocognitive tests may give insight into why a subject correctly or incorrectly answered a particular response. For example, if a subject thought about a particular response longer, the subject may be more likely to enter the correct response. On the other hand, if a subject responds more quickly, the subject may be more likely to enter an incorrect response. A keystroke diary may be generated for the subject's correct and incorrect responses. The keystroke diary may be used for diagnostic purposes to assess the subject's neurocognitive health and additionally may include a record of responses precise to the millisecond. The method is designed to produce results accurate to the millisecond on operating systems not accurate to the millisecond. The programming enhancements described herein are one example of a method for achieving millisecond accuracy on such operating systems.

In one exemplary implementation, a method for computer-based neurocognitive testing may be implemented using stand-alone agent software executable on a general purpose computing platform. The stand-alone agent software includes a test manager for administering neurocognitive tests to the subject. Exemplary types of neurocognitive tests that may be administered by the test manager include a verbal memory test, a visual memory test, a motor speed test, a fine motor control test, a complex attention test, a visual perception speed test, an information processing speed test, an executive function test, a reaction times, simple choice test, a speed-accuracy tradeoff assessment test, a cognitive flexibility test, or any other suitable neurocognitive test. Some of the above-listed tests are tests for which reaction times for individual responses were not conventionally measured. However, according to the present invention, the agent software preferably records reaction times for individual responses for these tests. The agent software is preferably capable of recording the reaction times with millisecond accuracy, even when executing over a non-real-time operating system. The agent software is preferably also capable of generating reports scoring the subject's responses and reaction times for individual responses in each test. One report may be generated immediately after the test session. Other more sophisticated clinically useful reports, such as longitudinal comparisons of the subject to peers and perhaps other dissimilar subjects, may also be generated by the agent or an associated server.

According to yet another aspect, the invention includes a system for a computer-based neurocognitive testing. The system includes the above-referenced stand-alone agent software for administering the tests to the subject, recording responses and reaction times for the responses. In addition, the system includes a server that receives the test results from the agent, stores the test results in a database, and controls access to the test results. In one example, the server may charge providers for access to the test results. In another example, the agent software may be downloadable via the server, and the server may charge providers for access to the agent software.

Accordingly, it is an object of the invention to provide improved methods and systems for computer-based neurocognitive testing that present a subject with a plurality of neurocognitive tests via a general purpose computing platform.

It is another object of the invention to provide methods and systems for computer-based neurocognitive testing that record reaction times for individual response in tests for which reaction times for individual responses were not conventionally measured.

It is yet another object of the invention to provide methods and systems for computer-based neurocognitive testing where a server receives test results from a stand-alone agent and controls access to the test results.

Some of the objects of the invention having been stated hereinabove, and which are addressed in whole or in part by the present invention, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings of which:

FIG. 1 is a block diagram of a system for computer-based neurocognitive testing environment according to an embodiment of the present invention;

FIG. 2 is a flow chart illustrating exemplary steps for administering computer-based neurocognitive testing according to an embodiment of the present invention;

FIG. 3 is a block diagram illustrating exemplary functions that may be used by an agent in obtaining neurocognitive measurements with millisecond accuracy according to an embodiment of the present invention;

FIG. 4 is a flow chart illustrating exemplary steps that may be performed by an agent in obtaining millisecond accuracy over a non-real-time operating system according to an embodiment of the present invention;

FIG. 5 is a block diagram illustrating exemplary components of a stand-alone agent for administering computer-based neurocognitive tests according to an embodiment of the present invention;

FIG. 6 is a diagram illustrating an exemplary computer screen display for a symbol digit coding test that may be administered by an agent according to an embodiment of the present invention;

FIG. 7 is a diagram illustrating an exemplary computer screen display for shifting attention test administered by an agent according to an embodiment of the present invention;

FIG. 8 is a flow chart illustrating exemplary steps that may be performed by an agent in administering a battery of neurocognitive test and recording reaction times according to an embodiment of the present invention; and

FIG. 9 is a table illustrating an exemplary agent report that may be created by agent software according to an embodiment of the present invention.

### DETAILED DESCRIPTION OF THE INVENTION

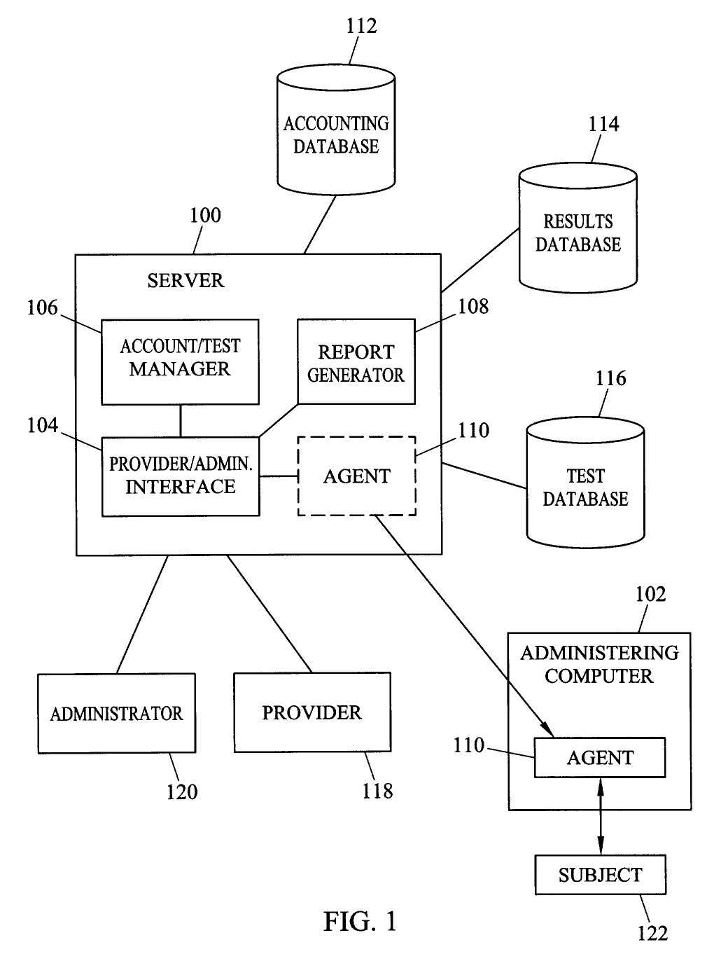

FIG. 1 is a block diagram of a system for computer-based neurocognitive testing according to an embodiment of the present invention. Referring to FIG. 1, the system includes a server 100 and a remote administering computer 102. Server 100 includes various software modules for controlling access to software for administering neurocognitive tests, obtaining the test results, generating reports, and performing accounting functions. In the illustrated example, server 100 includes a provider/administrator interface 104, an account/test manager 106, a report generator 108, and agent software 110. In addition, server 100 may include an accounting database 112, a results database 114, and a test database 116.

Provider/administrator 104 interface preferably provides a convenient interface to allow providers 118 and administrators 120 to obtain neurocognitive testing software and view test results. As used herein, the term “provider” refers to the party who is financially responsible for access to the neurocognitive test system. The term “administrator” refers to the party administering a test or battery of tests. In some situations, provider 118 and administrator 120 may be the same person. In other situations, provider 118 may be a physician and administrator 120 may be a technician, nurse, or other person who administers the test but who is not financially responsible for the test. In one exemplary implementation, provider/administrator interface 104 may be a web server that allows provider 118 and administrator 120 to establish an account for accessing server 100 via their respective web browsers.

Account/test manager 106 creates accounts, controls access to the accounts, and stores accounting data in accounting database 112 when a provider 118 or an administrator 120 accesses a battery of neurocognitive tests. Report generator 108 generates reports based on tests taken by a subject 122. As will be discussed in more detail below, report generator 108 and over time discovers biases in test results due to the different computing platforms on which tests may be administered.

Agent 110 may be downloadable computer software for administering a battery of tests to subject 122. Agent 110 is preferably capable of recording neurocognitive test results with millisecond accuracy, even when executing over a non-real-time operating system, such as WINDOWS® 95, 98, 2000, NT, ME, XP, or other non-real-time operating system. Once subject 122 completes a battery of tests, agent 110 may display or print an agent report and upload the results to results database 114. In a preferred embodiment of the invention, agent 110 is self-contained in that it does not require contact with server 100 or the presence of a browser or a virtual machine on administering computer 102 in order to administer tests to subject 122. Providing a stand-alone agent increases the accuracy of neurocognitive measurements as compared to conventional applet-based testing systems that require web browsers, browser plug-ins and JAVA virtual machines to execute. In addition, because agent 110 is preferably a stand-alone executable file, agent 110 is more likely to function properly on remote computing platforms located in subjects' homes.

Another aspect of agent 110 is that it is preferably capable of executing on a general purpose computing platform. Unlike conventional neurocognitive tests that require specialized hardware in order to measure a subject's reaction times, agent 110 according to the present invention is preferably capable of obtaining a subject's reaction times using a general purpose computing device and standard input devices, such as a mouse, a keyboard, and a display device. Providing an agent capable of executing and accurately recording reaction times on a general purpose computing platform provides increased versatility over conventional test systems that use special purpose hardware.

Yet another important aspect of agent 110 is the fact that it preferably records a subject's reaction times for individual responses in tests for which reaction times for individual responses have not conventionally been recorded. For example, in a conventional visual memory test, a subject was presented with a sequence of shapes in an in-person interview via flash cards and asked to remember the shapes. The subject was then shown a sequence of shapes with distracter shapes intermixed with the shapes that the subject was asked to remember. The subject was asked to write on a piece of paper whether the displayed shape is one of the shapes that the subject was asked to remember. In such a visual memory test, reaction times for individual response were not recorded because the primary purpose of the test was to measure the subject's memory. According to the present invention, reaction times for individual responses may be recorded for such neurocognitive tests. Recording reaction times individual response in neurocognitive tests for which reaction times for individual responses have not conventionally been measured facilitates neurocognitive diagnosis.

The present invention is not limited to downloading agent 110 from server 100 to administering computer 102. In instances in which test subjects or administrators do not have access to server 100, agent 110 may be distributed to an administrator 120 or subject 122 via a computer-readable medium, such as a magnetic or optical disk. Any method for distributing agent software 110 to administering computer 102 is intended to be within the scope of the invention.

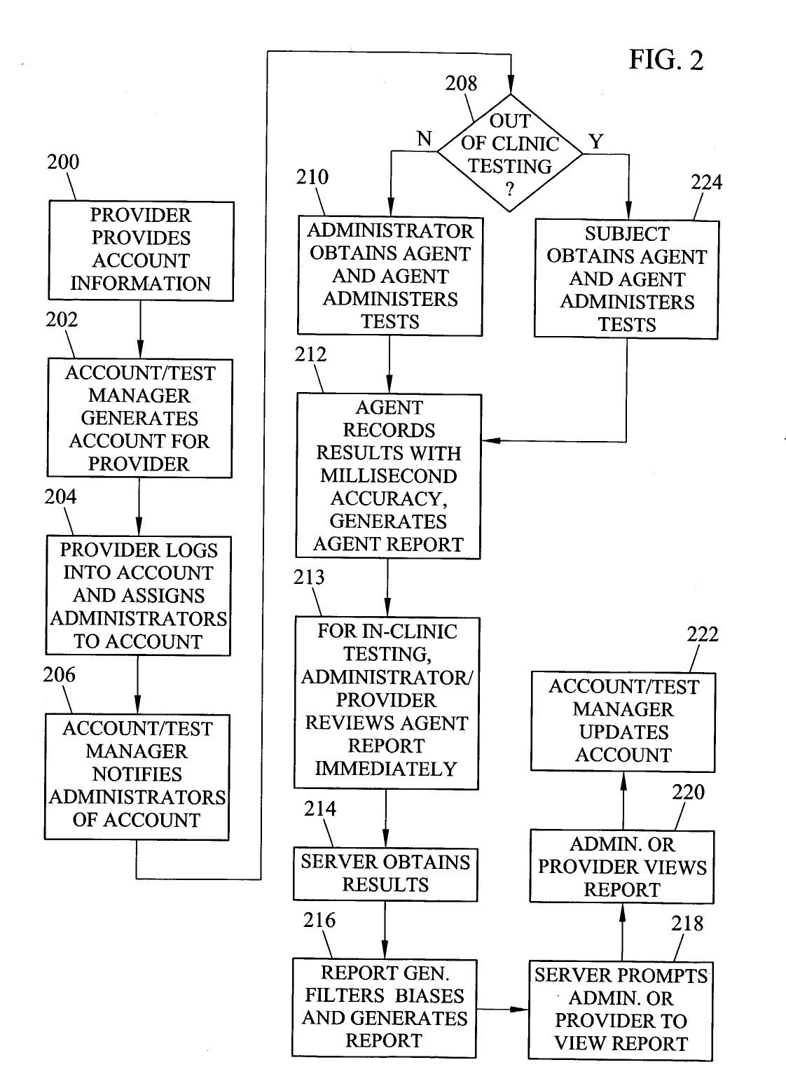

FIG. 2 is a flow chart illustrating the overall steps performed by the system illustrated in FIG. 1 in administering neurocognitive tests according to an embodiment of the present invention. Referring to FIG. 2, in step 200, provider 118 provides account information to the owner of the neurocognitive test system illustrated in FIG. 1. For example, provider 118 may access the website corresponding to provider/administrator interface 104 and provide billing information, such as credit card information or billing address information. In step 202, account/test manager 106 creates an account for the provider in database 112 and notifies provider 118 of successful completion of the account establishment. In an alternate implementation, provider 118 may provide the account information to the owner of the neurocognitive test system via telephone and a technician may enter the provider's account information in accounting database 112. Account establishment may include prompting provider 118 to select a user ID and a password and storing the user ID and password for subsequent authentication of provider 118.

Once provider 118 has established an account, in step 204, provider 118 logs into the account and assigns administrators 120 to the account. In assigning administrators, provider 118 may provide email addresses for each administrator 120. In step 206, account/test manager 106 notifies administrators 120 of the availability of neurocognitive tests. For example, account/tests manager 106 may notify administrators 120 via email. Each email may include URL for contacting server 100. In step 208, processing branches depending on whether the testing will be “out of clinic” such as at the subject's home or in a centralized location corresponding to administrator 120. If administrator 120 selects centralized testing, control proceeds to step 210 where administrator obtains the agent software, installs agent 110 on administering computer 102, and agent 110 administers the tests. Obtaining agent 110 may include downloading agent 110 from server 100 or loading agent 110 on administering computer 102 from a disk. In step 212, agent 110 records reaction times with millisecond accuracy and locally generates a report of test results, referred to herein as the agent report. In step 213, administrator 120 may view the agent report immediately. That is, the agent report may be generated locally on administering computer 102. Agent 110 may condition access to the agent report using an access code. Providing immediate local access to the agent report increase the efficiency of neurocognitive testing over systems that rely on a server to score test results.

In step 214, server 100 obtains the test results. Server 100 may obtain the test results by receiving an upload from agent 110. Alternatively, the test results may be stored on a disk storage medium and manually loaded onto server 100.

Once the test results are uploaded to server 100, report generator 108 may generate one or more reports based on the test results. Generating the reports may include comparing the subject's responses to results stored in results database 114. In addition, or, alternatively, generating the reports may include comparing the subject's responses to prior responses of the subject to determine changes in the subject's neurocognitive health over time. In one exemplary implementation, a subject may be assigned a unique identifier the first time that the subject accesses agent 110. Report generator 108 may store the unique identifier along with test results for the subject in database 114. The next time that the same subject accesses agent 110, report generator 108 may utilize the unique identifier to access prior results for the same subject. Associating a unique identifier with each subject's results allows subjects to change health care providers and easily transfer neurocognitive test results to the new provider.

As stated above, report generator 108 preferably filters and assesses CNS data, trends, and diagnoses and overtime may discover biases from the test results due to factors associated with administering computer 102. Exemplary factors that may be used by report generator 108 in filtering biases from report results include:

WINDOWS® OS version;

WINDOWS® service pack;

WINDOWS® DirectX version;

system keyboard type;

hardware processor type;

hardware processor family;

hardware processor speed;

hardware clock frequency;

dates, times, tests and fulltime

duration;

agent version; and

individual test versions.

The above-listed factors may be recorded by agent 110 using standard WINDOWS® functions. Any of the factors listed above may be used alone or in combination with other factors by a report generator 108 to decrease errors and biases in test data. For example, tests taken on a particular operating system version that results in inaccurate measurements may be excluded from statistical data. In addition, test data may be compensated based on hardware processor speed, clock speed, or other factors. In one exemplary implementation, agent 110 may reduce biases due to any of the above-listed factors by checking for minimum system requirements. If minimum system requirements are not met, agent 110 may prompt administrator 120 to obtain updated software or to move agent 110 to a different computer. If the minimum requirements are not met, agent 110 may either prevent administration of neurocognitive tests or mark test results to indicate noncompliance with minimum requirements. Thus, using the factors listed above, the present invention increases the accuracy of statistical and individual neurocognitive test results.

Returning to FIG. 2, in step 218, server 100 prompts the administrator to view the report generated by server 100. This action initiates the web browser on the administrator's computer, which displays the report to the administrator. In step 220, the administrator views the report. In step 222, account/test manager 100 charges the provider's account in database 112 for viewing the report. Such charges may be assessed on a per report basis or on a subscription basis. A system that automatically charges a provider for viewing neurocognitive test results provides new business opportunities for neurocognitive test providers. Alternatively, as described above, the provider may be charged a session fee for the number of sessions that the provider is permitted to execute agent 110. The number of sessions may be preprogrammed into agent 110 and agent 110 may maintain and decrement an internal session counter until the number of sessions reaches zero. At that time, agent 110 may prompt the provider to pay additional fees and obtain a new session key to execute additional sessions of agent 110.

Returning to step 208, if out-of-clinic testing, such as home testing, is selected, control proceeds to step 224 where the subject obtains agent 110, and agent 110 administers the tests on the subject's computer. If the subject has Internet access, the subject may obtain agent 110 by downloading agent 110 from server 100. Alternatively, if the subject does not have Internet access, the subject may obtain agent 110 by obtaining a disk storage device including agent 110 and loading agent 110 from the disk storage device onto administering computer 102. Once agent 110 is loaded onto administering computer 102 and the subject takes the tests, control proceeds to steps 212-222 where the agent records the results, the results are communicated to the server, and an administrator or the subject's physician views the reports. For in-home testing, agent 110 may not provide local access to the agent report, as indicated in step 213. Rather, server 100 may receive the results, notify the provider or administrator via email that the results are available for review, and provide access to the results via a secure hyperlink included in the email.

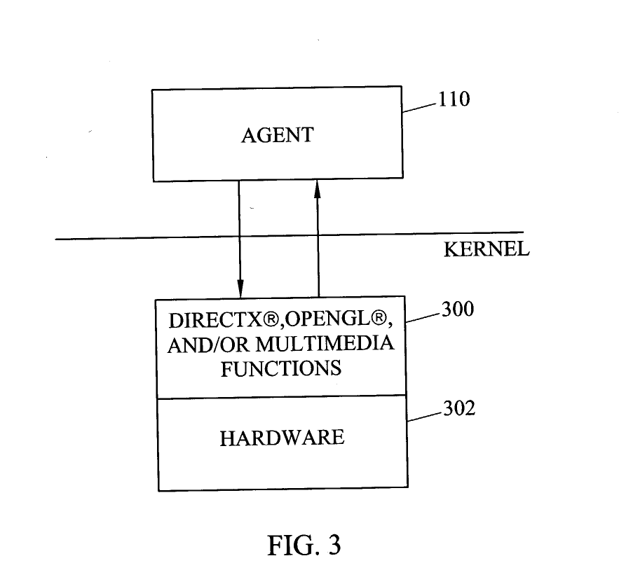

As described above, agent 110 preferably records neurocognitive test results with millisecond accuracy, even when executing over a non-real-time operating system. FIG. 3 is a block diagram illustrating exemplary functions that may be used by agent 110 for directly accessing hardware level functions. Referring to FIG. 3, agent 110 may utilize Direct®, OPENGL®, multimedia functions 300 to gain real-time access to hardware 302. Such functions provide direct access to hardware 302 so that the measurements recorded by agent 110 are as near real-time as possible. In one exemplary embodiment, agent 110 is capable of achieving accuracy on the order of milliseconds.

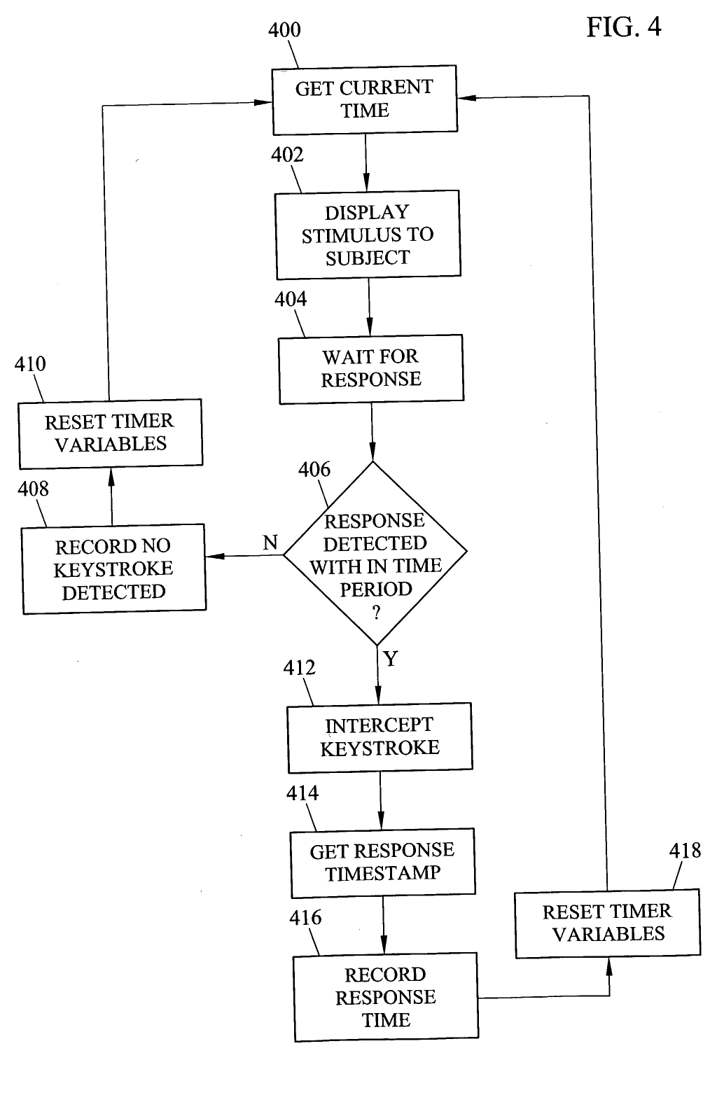

FIG. 4 is a flow chart illustrating exemplary steps that may be performed by agent 110 in recording real-time neurocognitive responses of a subject. Referring to FIG. 4, in step 400 agent 110 records the current time. In step 402, agent 110 displays a stimulus to the subject. In step 404, agent 110 waits for the response from the subject. In step 406, agent 110 determines whether the response has been detected within a predetermined time period. If a response has not been detected within a predetermined time period, control proceeds to step 408 where agent 110 records that no keystroke has been recorded. In step 410, all timer variables are reset, and control turns to step 400 where the next stimulus is presented to the subject.

In step 406, if a response is detected within a predetermined time period, control proceeds to step 412 where agent 110 intercepts the keystroke before it passes through the normal operating system stack. Intercepting the keystroke may be performed using DirectX® commands. In step 414, agent 110 records the response timestamp using WINDOWS® multimedia commands. In step 416, agent 110 records the reaction time for the response, which may simply include the storing time recorded in steps 400 and 414. In step 418, agent 110 resets the timer variables and control proceeds to step 400 where the test is repeated for the next stimulus. Thus, using the steps illustrated in FIG. 4, agent 110 is capable of achieving millisecond accuracy over a non-real-time operating system.

The following source code illustrates an example of a subroutine for obtaining millisecond neurocognitive measurements using the steps illustrated in FIG. 4:

bool shiftAttentionTest( )
{
// Variables
MMTimer timer, resTimer;
DWORD theKey, pressTime;
SndResource beep(hInstance, MAKEINTRESOURCE(IDR_WAV_BEEP));

| | |
|---|---|
| theKeyboard->acquire( ); | // Acquire exclusive keyboard access |
| countDown(ddWin, 3); | // Provide the user with a countdown |
| timer.markFuture(TEST_TIME); | // Set the test's run time |
| while(!timer.markReached( )) | // Loop until the test time has expired |
| { | |
| // Draw the screen | |
| drawScreen(testScreen[results->getCurrentTest( )], false); | // Draw the new stimuli on the screen buffer |
| ddWin->updateDisplay( ); | // Transfer the screen buffer to the display |
| resTimer.mark( ); | // Mark the current time. |
| thekeyboard->flush( ); | // Flush any early key presses |
| resTimer.markFutureFromMark(MAX_DISPLAY_TIME); | // Set stimuli display time |
| while(!resTimer.markReached( )) | // Loop until end of stimuli display time |
| { | |
| if(theKeyboard->getBufferedKeyTime(&theKey, &pressTime)) | // Check for any key presses |
| { | // Got a key press |
| results->markResponse(theKey, pressTime - resTimer.getMark( )); | // Store the key pressed and the time it was |
| | pressed |
| break; | // Move to next stimulus |
| } | |
| } | |
| // Display a blank screen between each stimulus | |
| ddWin->clear(BACKCOLOR); | // Clear the screen buffer |
| ddWin->updateDisplay( ); | // Transfer the screen buffer to the display |
| resTimermark( ); | // Mark the current time |
| resTimer.markFutureFromMark(HIDE_TIME); | // Set the blank screen time |
| while(!resTimer.markReached( )); | // Loop until time expired |
| results->nextTest( ); | // Move to the next stimulus |
| } | |
| theKeyboard->unacquire( ); | // Release the keyboard |
| } | |

The source code above is written in C++ and contains functions for drawing a stimulus on the screen and recording the subject's reaction times. The source code uses DirectX® and multimedia functions, such as drawScreen( ), getBufferedKeyTime( ), and markResponse( ) to record results in real-time. Comments on the right-hand side of the source code explain the purpose of each function.

The present invention is not limited to the source code above for recording reaction times with millisecond accuracy. Any function that provides direct access to hardware over a non-real-time operating system is intended to be within the scope of the invention. Because agent 110 uses functions that access hardware directly, biases and errors caused by different OS versions are reduced. In addition, because agent 110 preferably detects hardware and software versions and may condition access to the tests based on the administering computer meeting minimum requirements, biases due to testing on out-of-date systems are reduced.

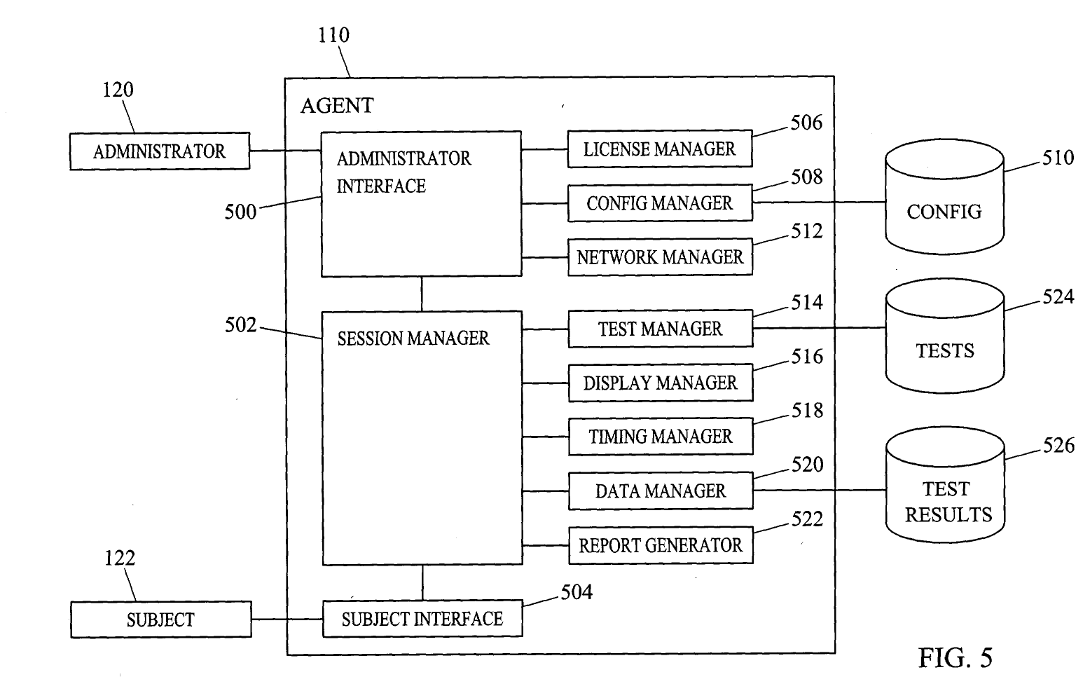

As stated above, agent 110 is preferably a stand-alone program capable of executing on a general purpose computing platform and does not require a connection to server 100 or the presence of a browser or a virtual machine on computer 102 in order to operate. FIG. 5 is a block diagram of an exemplary internal architecture for agent 110 according to an embodiment of the present invention. Referring to FIG. 5, the major components of agent 110 include an administrator interface 500, a session manager 502, and a subject interface 504. Administrator interface 500 interacts with administrator 120 for licensing, configuration, and network communications purposes. For example, administrator interface 500 may control communications between administrator 120 and a license manager 506. License manager 506 may display an end user license to administrator 120 and require administrator 120 to except or reject terms of the license. Configuration manager 508 may control tests that are included in a particular agent based on data stored in a configuration database 510. The tests that may be included may be configurable by administrator 120 or by a software developer. Configuration manager 508 may also verify that minimum system requirements are met and condition testing on these requirements being met. Network manager 512 may control communications between agent 110 and server 100. For example, network manager 512 may include a TCP/IP protocol stack for initiating connection with server 110.

Session manager 502 manages neurocognitive test sessions. In the illustrated example, session manager 502 interacts with a test manager 514, a display manager 516, a timing manager 518, a data manager 520, and a report generator 522. Test manager 514 administers tests stored as component files in the test database 524. Exemplary tests that may be included in agent 110 are neurocognitive tests, such as a visual memory test, a verbal memory test, a symbol digit coding test, a finger tapping test, a continuous performance test, or any other suitable neurocognitive tests. Display manager 516 controls screen displays to subject 122. For example, display manager 516 may use the WINDOWS® multimedia and DirectX® functions described above to display neurocognitive stimuli to a subject. Timing manager 518 controls the overall timing of agent 110. These timing functions may include recording responses with millisecond accuracy as described above. Data manager 520 stores subject responses to the tests in a test results database 526 which agent creates on administering computer 102. Report generator 522 generates the agent report mentioned above. Thus, as illustrated in FIG. 5, agent 110 may be a stand-alone component for administering neurocognitive tests and recording and displaying test results.

As described above, agent 110 preferably administers a battery of neurocognitive tests to the subject and records responses and reaction times for the responses, even in tests for which reaction times for individual responses were not conventionally measured. One type of neurocognitive test that may be administered by agent 110 is a verbal memory test. In one exemplary verbal memory test, agent 110 may display fifteen target words in sequence to the subject. The words may be displayed one at a time on separate computer display screens. The words may be displayed for a predetermined time period, such as two seconds. The subject is asked to remember each word.

Once the display of the target words is completed, agent 110 displays a second sequence of words to the subject. The subject is asked to press the spacebar if the displayed word is one of the target words that were displayed to the subject. Distracter words are randomly intermixed with the original target words that the subject was asked to remember. The subject is instructed to do nothing if one of the distracter words appears on the screen. Agent 110 may administer this test multiple times to gauge memory degradation.

In conventional verbal memory test, reaction times for individual responses were not recorded. A subject was simply graded on the whether the subject correctly remembered one of the target words. According to the present invention, agent 110 preferably records the subject's reaction time for each response and the total time for taking the verbal memory test. This data can be used to facilitate neurocognitive diagnosis.

Another type of test that may be administered by agent 110 is a visual memory test. In a visual memory test, agent 110 displays target shapes to the subject and the subject is asked to remember the shapes. The shapes may be displayed one shape per screen on a computer display device. Each shape may be displayed for a predetermined time period, such as two seconds. Once the target shapes have been displayed, agent 110 displays distracter shapes randomly intermixed with the target shapes that the subject was asked to remember. The subject is instructed to press the space bar if the shape was one of the shapes that the subject was asked to remember. The subject is instructed to do nothing if one of the distracter shapes is displayed. Agent 110 may repeat the visual memory test near the end of a test session to gauge memory degradation.

The visual memory test is another example of a neurocognitive test for which reaction times for individual responses were not conventionally measured. However, according to the present invention, agent 110 preferably records the subject's reaction time for each response in the visual memory test and the total time for taking the visual memory test. The reaction times are preferably recorded with millisecond accuracy. These measures may be of interest for neurocognitive health diagnosis. For example, a diary of reaction times for individual responses may provide insight as to why a subject answered correctly or incorrectly for a particular response.

Yet another type of test that may be administered by agent 110 is a motor speed test, such as a finger tapping test. In administering the finger tapping test, agent 110 may request that the subject tap the left shift key as many times as possible within a predetermined time period with the subject's left index finger. Agent 110 may request that the subject repeat the test multiple times for the left index finger. Agent 110 may then request that the subject repeat the test with the right index finger and the right shift key. Agent 110 preferably records the subject's responses with millisecond accuracy and averages the results.

Conventional finger tapping tests require special purpose hardware. As discussed above, agent 110 preferably implements the finger tapping test using standard input/output devices, such as a keyboard. As a result, agent 110 makes finger tapping tests easier to administer to multiple subjects.

Yet another example of a neurocognitive test that may be administered by agent 110 is a fine motor control test. One example of a fine motor control test that may be administered by agent 110 is a finger tapping test. The finger tapping test is discussed in detail above. Hence a description thereof will not be repeated herein.

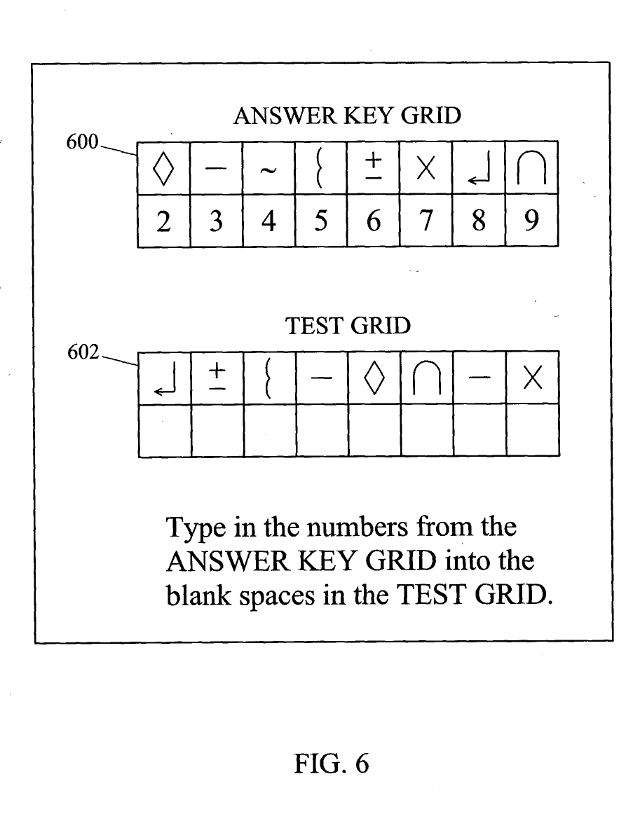

Another type of neurocognitive test that may be administered by agent 110 is a complex attention test. One example of a complex attention test that may be administered by agent 110 is a symbol digit coding test. In a symbol digit coding test, a subject is asked to match or code numbers from a key of numbers to symbols matrix to an incomplete matrix needing numbers to match with the symbols. The subject attempts to do as many tests as possible in an allotted time period. FIG. 6 is an example of a computer screen display from a symbol digit coding test that may be administered by agent 110 according to an embodiment of the present invention. In FIG. 6, an answer key grid 600 contains symbols and numbers corresponding to the signals. A test grid 602 contains symbols in a different order than the symbols in the answer key grid. Some of the symbols may be repeated. The subject is asked to type the correct numbers from answer key grid 600 into blank spaces in test grid 602. In administering the test, agent 110 may present different answer key grids and test grids to the subject.

In a conventional symbol digit coding test, the total number, of grids completed by the subject and the total time for completing a predetermined number of grids may have been recorded. However, the subject's reaction time in completing individual grids has not conventionally been recorded. Using the capabilities discussed above, agent 110 may record the subject's reaction time for completing individual test grids and for each response within a grid. Such new data may be used to facilitate neurocognitive diagnosis.

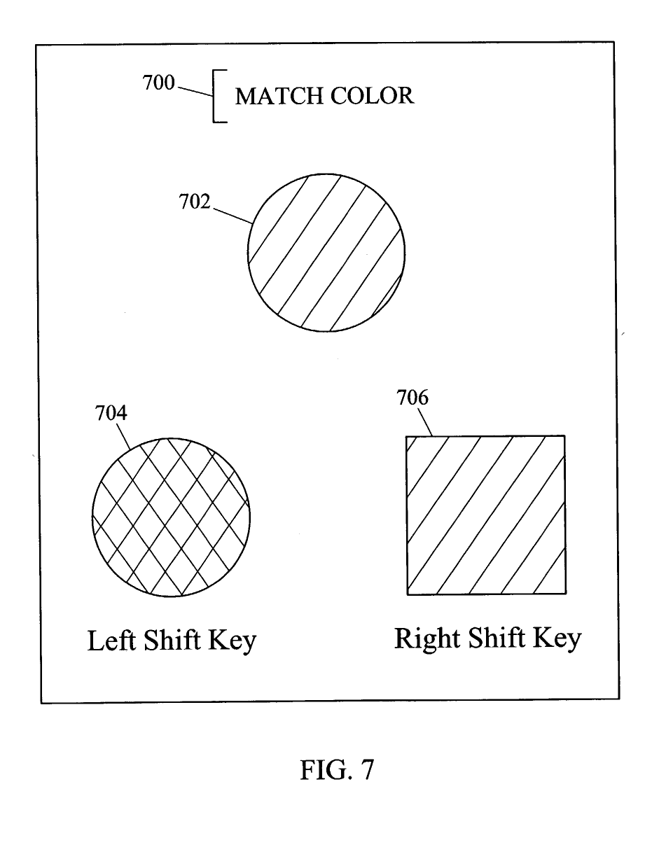

Yet another example of a complex attention test that may be administered by agent 110 is a shifting attention test. In a shifting attention test, the subject is asked to react to changing rules and changing targets. The rule may be either choose color or choose shape. The target may be either a predetermined shape of a predetermined color, such as a red square, a red circle, a blue square, or a blue circle. The subject is asked to press a predetermined response key based on the rule and the displayed shapes. FIG. 7 illustrates an exemplary computer screen display that may be displayed by agent 110 in administering a shifting attention test to a subject according to an embodiment of the present invention. Referring to FIG. 7, a rule 700, such as “match color” or “match shape” is displayed to the subject. A target shape 702 of a predetermined color is displayed to the subject. In the illustrated example, the hash marks represent different colors. At the bottom of the screen, a shape 704 of a different color than shape 702 is displayed to the subject. Another shape 706 that is of a different shape but the same color as shape 702 is displayed to the subject. In this example, because rule 700 requires that the subject match the color of shape 702, the subject 702 preferably selects shape 706 by pressing the right shift key. Different combinations of colors and shapes may be displayed to the subject.

As with the memory tests described above, the subject's reaction times for individual responses were not conventionally measured in the shifting attention test. However, agent 110 according to the present invention may measure the subject's reaction time for each screen and determine preferences for rules relating to colors or shapes and response times for the subject's left and right hands. Reaction time for an individual response may be used explain why the response was correct or incorrect. As a result, administering a shifting attention test in this manner may facilitate neurocognitive diagnosis. For example Yet another type of test that may be administered by agent 110 is a visual perception speed test. An example of a visual perception speed test that may be administered by agent 110 is a symbol digit coding test. An example of a symbol digit coding test is described above with respect to FIG. 6.

Yet another type of neurocognitive test that may be administered by agent 110 is an information processing speed test. One example of an information processing speed test that may be administered by agent 110 is a symbol digit coding test, as described above. Another example of an information processing speed test that may be administered by agent 110 is a Stroop test. A Stroop test administered by agent 110 may include three parts. In the first part, agent displays words to the subject on a computer screen. The subject is asked to press the spacebar as soon as any word is displayed. The purpose of this test is to measure simple reaction time.

The second part of the Stroop test requires the subject to press the spacebar when the name of the word matches the color of the word, measuring the subject's choice reaction time. For example, the word “yellow” may be displayed in a yellow font. If the font colors matches the word, the subject is requested to press the spacebar. If the font color does not match the word, the subject is requested to do nothing. The third part of the Stroop test administered by agent 110 requests that the subject press the spacebar when the name of the word does not match the color of the word. For example, when the word red is displayed in a green font, the correct response is for the subject to press the spacebar. When the font color and word match, the correct response is for the subject to do nothing. This test measures Stroop reaction time and cognitive flexibility.

Even in conventional Stroop tests, reaction times for individual responses may not have been conventionally measured. Rather, the average response time may have been measured. When administering the Stroop test, agent 110 preferably measures a subject's reaction time for individual responses. The reaction times are preferably recorded with millisecond accuracy. As a result, agent 110 provides more comprehensive data for neurcognitive analysis than conventional Stroop tests.

Another example of an information processing speed test that may be administered by agent 110 is a shifting attention test. An example of a shifting attention test is described above with respect to FIG. 7. As described, agent 110 preferably administers the shifting attention test and measures the subject's reaction times for individual responses, which may be used to facilitate neurocognitive diagnosis.

Another type of test that may be administered by agent 110 is an executive function test. Examples of executive function tests that may be administered by agent 110 are the Stroop test and the shifting attention test, as described above.

Another type of test that may be administered by agent 110 is a reaction times-simple choice test. Examples of reaction times-simple choice test that may be administered by agent 110 are the Stroop test and the continuous performance test. An example of a Stroop test that may be administered by agent 110 is described above. In a continuous performance test, agent 110 may present the subject with stimuli and directions to press the spacebar when a certain letter appears. The duration of the test may be a predetermined time period, such as five minutes. In one example, a sequence of alphanumeric characters is displayed to the subject and the subject is asked to press the spacebar only when the letter B appears. The time between appearances of the letter B may be random. The purpose of this test is to measure reaction time and attention.

Conventional versions of the shifting attention test may not have recorded a subject's reaction times for individual responses. Rather, the subject's reaction times may have been averaged. Agent 110 preferably records a subject's reaction times for individual responses in the shifting attention test and even more preferably records such reaction times with millisecond accuracy. As a result, agent 110 provides more comprehensive data for neurocognitive analysis than conventional shifting attention tests.

Still other types of tests that may be administered by agent 110 include speed accuracy-tradeoff assessment tests and cognitive flexibility tests. Examples of speed accuracy-tradeoff assessment tests include Stroop tests, shifting attention tests, and symbol digit coding tests as described above. An example of a cognitive flexibility test is the Stroop test, as described above.

Although many different tests have been described herein, the present invention is not limited to only administering the tests listed and described herein. Agent 110 may administer any suitable type of neurocognitive test and record reaction times for individual response, whether reaction times were recorded or not recorded in conventional versions of the test.

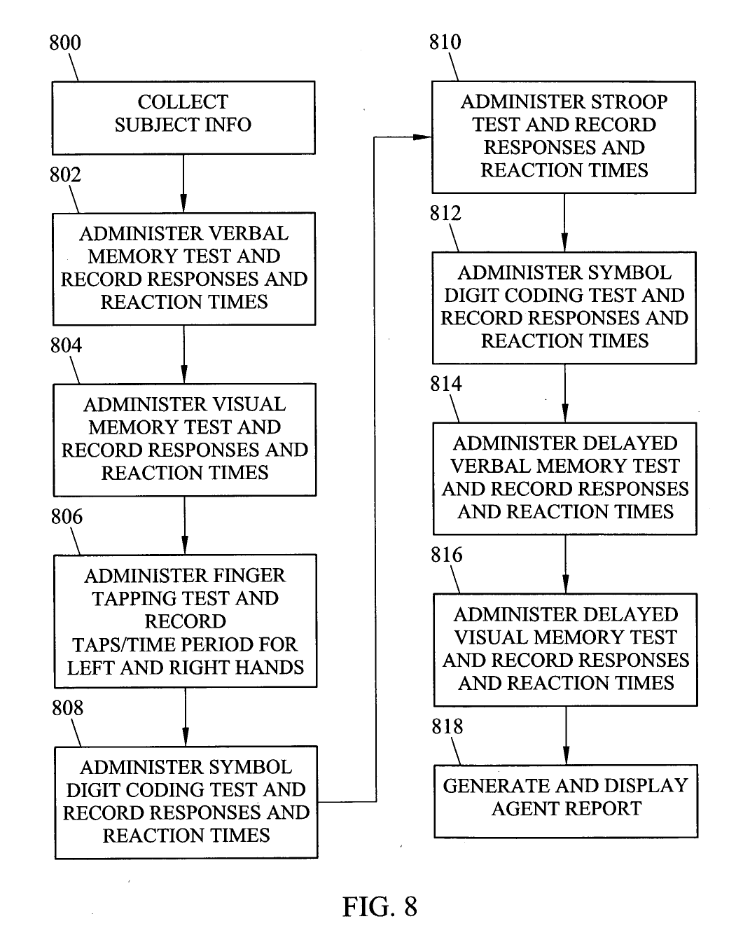

In a given test session, agent 110 may administer a battery of tests to the subject, record the subject's responses and reaction times for individual responses in each test, and generate an agent report. FIG. 8 illustrates exemplary steps that may be performed by agent 110 in administering a battery of neurocognitive tests to a subject and recording the subject's responses and reaction times. Referring to FIG. 8, in step 800, agent 110 collects subject information. Such information may include demographic information, such as the subject's age, race, nationality, and neurocognitive health. In step 802, agent 110 initiates the session by administering a verbal memory test to the subject and records the subject's responses and reaction times.

Once the verbal memory test has been completed, in step 804, agent 110 administers a visual memory test to the subject and records the subject's responses and reaction times. Once the visual memory test is completed, in step 806, agent 110 administers a finger tapping test to the subject. The finger tapping test may be repeated for the subject's left and right index fingers. Agent 110 may record the number of taps per time period for each iteration of the test.

In step 808, agent 110 administers a symbol digit coding test to the subject, records the subject's responses and reaction times. In step 810, agent 110 administers the Stroop test to the subject and records the subject's responses and reaction times. In step 812, agent 110 administers the symbol digit coding test to the subject and records the subject's responses and reaction times to the test.

In step 814, agent 110 administers a delayed verbal memory test to the subject and records the subject's responses and reaction times. The delayed verbal memory test may request that the subject remember the same words that were displayed to the subject in the first iteration of the test in step 802. In step 816, agent 110 administers a delayed visual memory test to the subject and records the subject's responses and reaction times for the responses. The delayed visual memory test may request that the subject remember the same shapes displayed to the subject in step 804.

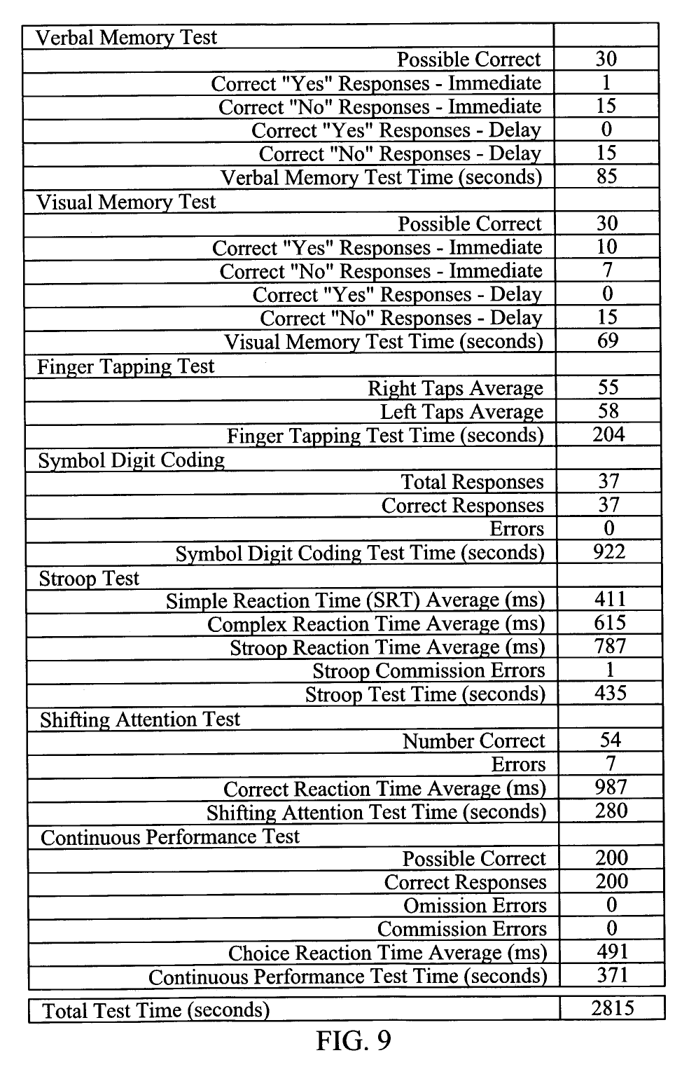

Finally, in step 818, agent 110 may generate and display an agent port. FIG. 9 illustrates an example of an agent report that may be displayed by agent 110. In the exemplary report illustrated in FIG. 9, correct responses and incorrect responses for each test are displayed. In addition, a total test time for each test and for all of the test is displayed. Reaction times are displayed for some of the tests. However, as discussed above, an agent according to the present invention may collect reaction times for all responses and all tests. Such results may be used to facilitate neurocognitive diagnosis.

Thus, the present invention includes improved methods and systems for computer-based neurocognitive testing. The fact that agent 110 is capable of executing on a general purpose computing platform using standard input/output devices provides increased versatility over conventional solutions that require special purpose hardware. In addition, because agent 110 preferably records reaction times for individual responses in neurocognitive test for which reaction times for individual responses were not conventionally recorded, the results gathered by agent 110 may facilitate neurocognitive diagnosis. Finally, because agent 110 is preferably a stand-alone program, the need for browsers, network connections, and virtual machines in administering neurocognitive tests is reduced.

It will be understood that various details of the invention may be changed without departing from the scope of the invention. Furthermore, the foregoing description is for the purpose of illustration only and not for the purpose of limitation, as the invention is defined by the claims as set forth hereinafter.

What is claimed is:

1. A method for computer-based neurocognitive testing, the method comprising:
using a general purpose computing platform:
(a) presenting a subject with one or more neurocognitive tests, at least one of the neurocognitive tests being a test in which reaction times for individual responses were not conventionally recorded;
(b) for each of the neurocognitive tests, recording the subject's responses; and
(c) recording the subject's, reaction time for at least one response in the test in which reaction times for individual responses were not conventionally measured.

2. The method of claim 1 wherein presenting a subject with one or more neurocognitive tests via a general purpose computing platform includes presenting the subject with a verbal memory test via the general purpose computing platform and wherein recording the subject's reaction time includes recording the subject's reaction time for individual responses in the verbal memory test.

3. The method of claim 1 wherein presenting a subject with one or more neurocognitive tests via a general purpose computing platform includes presenting the subject with a visual memory test via the general purpose computing platform and wherein recording the subject's reaction time includes recording the subject's reaction times for individual responses in the visual memory test.

4. The method of claim 1 wherein presenting a subject with one or more neurocognitive tests via a general purpose computing platform includes presenting the subject with a motor speed test via the general purpose computing platform and wherein recording the subject's reaction time includes recording the subject's reaction times for individual responses in the motor speed test.

5. The method of claim 1 wherein presenting a subject with one or more neurocognitive tests via a general purpose computing platform includes presenting the subject with a fine motor control test via the general purpose computing platform and wherein recording the subject's reaction time includes recording the subject's reaction times for individual responses in the fine motor control test.

6. The method of claim 1 wherein presenting a subject with one or more neurocognitive tests via a general purpose computing platform includes presenting the subject with a complex attention test via the general purpose computing platform and wherein recording the subject's reaction time includes recording the subject's reaction times for individual responses in the complex attention test.

7. The method of claim 1 wherein presenting a subject with one or more neurocognitive tests via a general purpose computing platform includes presenting the subject with a visual perception speed test via the general purpose computing platform and wherein recording the subject's reaction time includes recording the subject's reaction times for individual responses in the visual perception speed test.

8. The method of claim 1 wherein presenting a subject with one or more neurocognitive tests via a general purpose computing platform includes presenting the subject with a executive function test via the general purpose computing platform and wherein recording the subject's reaction time includes recording the subject's reaction times for individual responses in the executive function test.

9. The method of claim 1 wherein presenting a subject with one or more neurocognitive tests via a general purpose computing platform includes presenting the subject with a reaction times, simple choice test via the general purpose computing platform and wherein recording the subject's reaction time includes recording the subject's reaction times for individual responses in the reaction times, simple choice test.

10. The method of claim 1 wherein presenting a subject with one or more neurocognitive tests via a general purpose computing platform includes presenting the subject with a speed-accuracy tradeoff assessment test via the general purpose computing platform and wherein recording the subject's reaction time includes recording the subject's reaction times for individual responses in the speed-accuracy tradeoff assessment test.

11. The method of claim 1 wherein presenting a subject with one or more neurocognitive tests via a general purpose computing platform includes presenting the subject with a cognitive flexibility test via the general purpose computing platform and wherein recording the subject's reaction time includes recording the subject's reaction times for individual responses in the cognitive flexibility test.

12. The method of claim 1 wherein implementing steps (a)-(c) on a general purpose computing platform includes implementing steps (a)-(c) using stand-alone agent software executing on the general purpose computing platform.

13. The method of claim 12 wherein performing steps (a)-(c) using stand-alone agent software includes performing steps (a)-(c) using stand-alone agent software that does not require a network connection.

14. The method of claim 1 wherein recording the subject's reaction time includes recording the subject's reaction time for individual responses with millisecond accuracy.

15. The method of claim 14 wherein recording the subject's reaction time with millisecond accuracy includes recording the subject's reaction time with millisecond accuracy when executing steps (a)-(c) over a non-real-time operating system.

16. The method of claim 1 wherein recording the subject's reaction time includes utilizing software functions that provide direct access to system hardware, thereby reducing biases in recording the reaction time caused by operating system version.

17. The method of claim 1 comprising determining whether the general purpose computing platform meets minimum system requirements before administering the neurocognitive tests.

18. The method of claim 1 comprising generating a report local to the general purpose computing platform based on the subject's responses to the neurocognitive tests.

19. The method of claim 1 comprising uploading the subject's responses and recorded reaction time to a neurocognitive test server.

20. The method of claim 19 comprising at the neurocognitive test server, generating a report based on the subject's responses and reaction time, the report including a longitudinal comparison of the subject's responses and reaction time to responses and reaction times from other similar and dissimilar subjects.

21. The method of claim 19 comprising, at the server, filtering biases from the subject's responses and reaction time.

22. The system of claim 21 comprising adding the subject's responses and reaction time to a neurocognitive test database.

23. The method of claim 1 wherein presenting the user with one or more neurocognitive tests includes presenting the user with first and second groups of neurocognitive tests, the first group including neurocognitive tests for which reaction times for individual responses were not conventionally recorded and the second group including tests for which reaction times for individual responses were conventionally measured and wherein recording the subject's reaction time includes recording the subject's reaction times for individual responses in at least one test in each group.

24. The method of claim 1 comprising using the reaction time to facilitate neurocognitive diagnosis.

25. A stand-alone agent for administering neurocognitive tests to a user via a general purpose computing platform, the agent comprising:
(a) a test manager for presenting a subject with one or more neurocognitive tests via a general purpose computing platform, at least one of the neurocognitive tests being a test for which reaction times for individual responses were not conventionally recorded;
(b) a data manager for recording the subject's response to each of the neurocognitive tests via the general purpose computing platform; and
(c) a timing manager for recording the subject's reaction time for at least one response in the test for which reaction times for individual responses were not conventionally measured.

26. The stand-alone agent software of claim 25 wherein the test manager is adapted to present the subject with a verbal memory test via the general purpose computing platform and the timing manager is adapted to record the subject's reaction times for individual responses in the verbal memory test.

27. The stand-alone agent software of claim 25 wherein the test manager is adapted to present the subject with a visual memory test via the general purpose computing platform and the timing manager is adapted to record the subject's reaction times for individual responses in the visual memory test.

28. The stand-alone agent software of claim 25 wherein the test manager is adapted to present the subject with a motor speed test via the general purpose computing platform and the timing manager is adapted to record the subject's reaction times for individual responses in the motor speed test.

29. The stand-alone agent software of claim 25 wherein the test manager is adapted to present the subject with a fine motor control test via the general purpose computing platform and the timing manager is adapted to record the subject's reaction times for individual responses in the fine motor control test.

30. The stand-alone agent software of claim 25 wherein the test manager is adapted to present the subject with a complex attention test via the general purpose computing platform and the timing manager is adapted to record the subject's reaction times for individual responses in the complex attention test.

31. The stand-alone agent software of claim 25 wherein the test manager is adapted to present the subject with a visual perception speed test via the general purpose computing platform and the timing manager is adapted to record the subject's reaction times for individual responses in the visual perception speed test.

32. The stand-alone agent software of claim 25 wherein the test manager is adapted to present the subject with an executive function test via the general purpose computing platform and the timing manager is adapted to record the subject's reaction times for individual responses in the executive function test.

33. The stand-alone agent software of claim 25 wherein the test manager is adapted to present the subject with a reaction time, simple choice test via the general purpose computing platform and the timing manager is adapted to record the subject's reaction times for individual responses in the reaction time, simple choice test.

34. The stand-alone agent software of claim 25 wherein the test manager is adapted to present the subject with a speed-accuracy tradeoff assessment test via the general purpose computing platform and the timing manager is adapted to record the subject's reaction times for individual responses in the speed-accuracy tradeoff assessment test.

35. The stand-alone agent software of claim 25 wherein the test manager is adapted to present the subject with a cognitive flexibility test via the general purpose computing platform and the timing manager is adapted to record the subject's reaction times for individual responses in the cognitive flexibility test.

36. The stand-alone agent software of claim 25 wherein the timing manager is adapted to measure the subject's responses with millisecond accuracy.

37. The stand-alone agent software of claim 36 wherein the timing manager is adapted to measure the subject's reaction times for individual responses with millisecond accuracy when executing over a non-real-time operating system.

38. The agent software of claim 25 comprising a report generator for generating an agent report local to the general purpose computing platform.

39. The stand-alone agent software of claim 25 wherein the data manager is adapted to upload the subject's responses to a server and wherein the server is adapted to compare the subject's responses to responses from other similar and dissimilar subjects.

40. A system for computer-based neurocognitive testing, the system comprising:
(a) stand-alone agent software executable on a general purpose computing platform for administering one or more neurocognitive tests to a subject, the neurocognitive tests including at least one test in which reaction times for individual responses were not conventionally recorded, the stand-alone agent software for recording the subject's responses to the tests and for recording a reaction time for at least one response in the test in which reaction times for individual responses were not conventionally recorded; and
(b) a neurocognitive testing server operatively associated with the stand-alone agent software for receiving the subject's responses and reaction time, for storing the responses and reaction time in a database, and for controlling access to the responses and reaction time.

41. The system of claim 40 wherein the stand-alone agent software is adapted to administer at least one of a verbal memory test, a visual memory test, a motor speed test, a fine motor control test, a complex attention test, a visual perception speed test, an executive function test, a reaction times, simple choice test, a speed-accuracy tradeoff assessment test, and a cognitive flexibility test to the subject.

42. The system of claim 41 wherein the stand-alone agent software is adapted to record the subject's reaction times for individual responses in each test with millisecond accuracy.

43. The system of claim 42 wherein the stand-alone agent is adapted to record the subject's reaction times with millisecond accuracy when executing on a non-real-time operating system.

44. The system of claim 40 wherein the agent is adapted to generate a report local to the general purpose computing platform without contacting the server.

45. The system of claim 40 wherein the server is adapted to receive the subject's responses and reaction time from the agent via a network connection.

46. The system of claim 40 wherein the server is adapted to obtain the results and the reaction time from the agent via a computer readable storage medium.

47. The system of claim 40 wherein the server is adapted to filter biases from the responses using the reaction time.

48. The system of claim 40 wherein the server is adapted to charge providers a fee for access to the responses and reaction time.

49. The system of claim 40 wherein the agent software is downloadable via the server and the server is adapted to charge providers a fee for access to the agent software.
